(19) United States
(12) Patent Application Publication
(10) Pub. No.: US 2006/0047762 A1
(43) Pub. Date: Mar. 2, 2006

(54) Method of generating a certified email return receipt

(76) Inventors: Daisy Feng-Mei Su, Naperville, IL (US); Frances Mu-Fen Chin, Naperville, IL (US); Peggy Hasan, Aurora, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/930,653

(22) Filed: Aug. 31, 2004

(51) Int. Cl. G06F 15/16

(52) U.S. Cl. 709/206

(57) ABSTRACT

A method of generating a certified email return receipt is provided. The method includes receiving an email requiring a certified email return receipt in a locked condition, prompting a person attempting to open the email to enter certified email return receipt information, collecting the certified email return receipt information entered by the person attempting to open the email, unlocking the email thereby enabling the email to be opened after the collecting step, opening the email after the collecting step for the person who entered the certified email return receipt information, and generating a certified email return receipt certifying that the email was received by the person who entered the certified email return receipt information.

### BACKGROUND OF THE INVENTION

This invention relates to the art of computer assisted communications and more particularly to communications delivered via electronic mail, also referred to as email.

Prior to the proliferation of computers and computer assisted communications, written communications such as letters were transported from sender to recipient via hand-carried postal mail services. With postal mail, these communications are carried by hand by a mail carrier, also known as a postal carrier or postal worker, and delivered to the addressee also referred to as the recipient.

The feature known as Certified Mail was established to meet the need of providing verification of the delivery of the written communication to the recipient. The sender can subscribe to this feature by requesting Certified Mail and paying a fee when mailing the communication to the recipient, typically from a post office. The delivery of the communication to the recipient is certified by the collection of information from the person accepting the communication. Typically, certification of delivery is accomplished by collecting the signature of the person accepting the communication from the postal carrier. Subscribers to this feature can subsequently retrieve a delivery record, or receipt, certifying the delivery of the communication.

With the advent of computers, a world-wide system of computer networks known as the Internet, or World Wide Web, has enabled a computer connected to this network to communicate with almost any other connected computer regardless of it's location. Email has evolved utilizing this effective form of computer-to-computer communication to provide an efficient form of communication between a sender of an email and a recipient thereof. The sender simply creates the email using any one of a variety of readily available email software applications and sends the email over the Internet to the recipient's email address. The recipient can open the email using a computer connected to the Internet using email software and read the email contents at a convenient time. As a result, email has become very popular, surpassing postal mail as the favored form of communication.

The need for verified delivery of emails has been met by email software applications providing an indication that the email was delivered to the recipient's email account. However, this verification method is typically activated only if the recipient has turned on the function to generate and send a return receipt. It is desirable to provide a return receipt feature certifying that the recipient has received the email in which the recipient cannot opt out of through simple deactivation.

### SUMMARY OF THE INVENTION

According to the present invention, a method of generating a certified email return receipt is provided.

In accordance with a first aspect of the invention, the method includes receiving an email requiring a certified email return receipt in a locked condition, prompting a person attempting to open the email to enter certified email return receipt information, collecting the certified email return receipt information entered by the person attempting to open the email, unlocking the email thereby enabling the email to be opened after the collecting step, opening the email after the collecting step for the person who entered the certified email return receipt information, and generating a certified email return receipt certifying that the email was received by the person who entered the certified email return receipt information.

In accordance with a second aspect of the invention, the method also includes sending the email return receipt to the sender.

In accordance with a third aspect of the invention, the method also includes storing the email return receipt in an email return receipt database.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The invention may take form in various components and arrangements of components, and in various steps and arrangements of steps. The drawings are only for purposes of illustrating preferred embodiments and are not to be construed as limiting the invention. Further, it is to be appreciated that the drawings are not to scale.

FIG. 1 is a block diagram illustrating a system for generating an email return receipt in accordance with the invention;

FIG. 2 is a flow chart illustrating a portion of a method of generating an email return receipt in accordance with the invention;

FIG. 3 is a flow chart illustrating a portion of a method of generating an email return receipt in accordance with the invention;

FIG. 4 is a flow chart illustrating a portion of a method of generating an email return receipt in accordance with the invention;

FIG. 5 illustrates a form prompting a person attempting to open an email requiring a certified email return receipt to enter certified email return receipt information; and

FIG. 6 illustrates an example of a certified email return receipt generated in accordance with the invention.

### DETAILED DESCRIPTION OF THE INVENTION

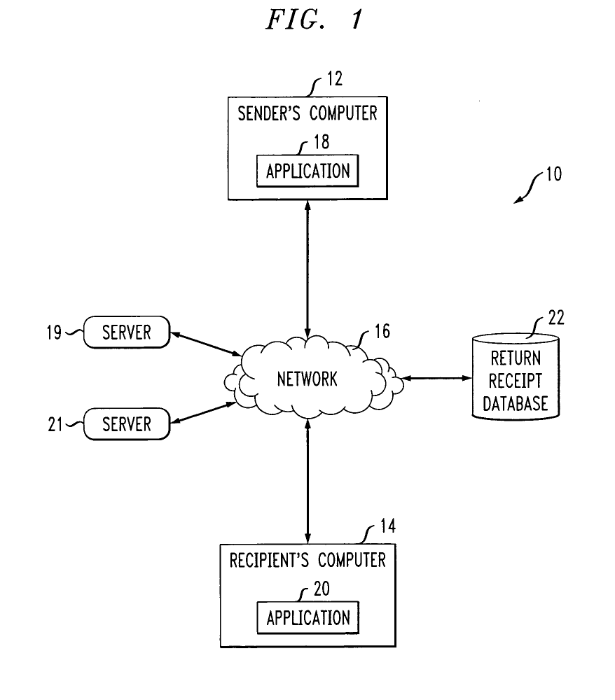

Referring to FIG. 1, a computing system for the sending and receiving of emails requiring a certified email return receipt, also referred to herein as a return receipt, is shown generally at 10. The computing system 10 provides email communication between a sender's computer 12 and a recipient's computer 14 over a network 16 such as an intra net or the Internet, also known as the World Wide Web.

The sender prepares and sends an email to the recipient using an email application 18 running on the sender's computer 12. Alternatively, the email application 18 or portions thereof may be running on a computer (not shown) connected with the sender's computer 12, such as for example a local server or an Internet Service Provider 19. The recipient receives the email using an email application 20 running on the recipient's computer 14. Alternatively, the email application 20 or portions thereof may be running on a computer (not shown) connected with the recipient's computer 14, such as for example a local server or an Internet Service Provider 21. The email applications 18, 20 can be any suitable software applications, or the same application, for creating, sending and receiving emails such as for example, Microsoft Outlook®, Netscape Messenger®, and others which can be modified by persons skilled in the art to provide the certified email return receipt feature described herein.

The computing system 10 also can include an email return receipt database 22 connected to the email applications 18, 20 in any suitable known manner for storing email return receipts and information pertaining thereto as shall be described in further detail below.

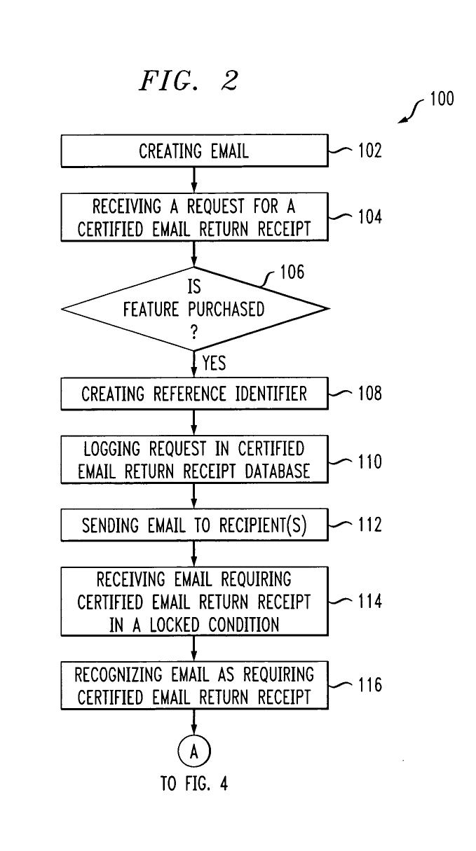

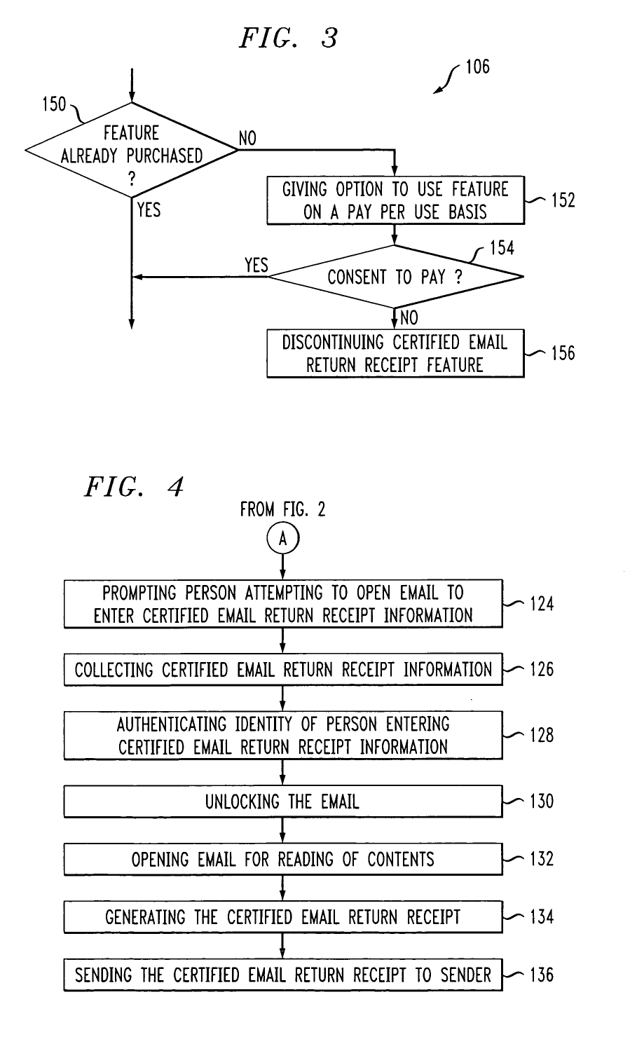

Referring now to FIG. 2, a method of generating a certified email return receipt is shown generally at 100. The method 100 can include a sender creating an email at 102 via the email application 18. The email includes contents, such as a message or an attachment, which can be read when the email is opened. The email can also include a subject portion having a short summary indicating the subject of the email. The email can also have a “Cc” portion which stands for carbon copy. Other recipients who will receive the email can be addressed in the Cc portion in a known manner.

The method 100 can also include the sender's email application 18 receiving a request from the sender for a certified email return receipt at 104. The sender can indicate this request by clicking on an icon or in any suitable known manner for requesting a software application feature. The email is then marked with an email return receipt request indicator indicating that the email requires an email return receipt. The indicator can be a flag or any other suitable known indicator which can be recognized by the recipient's email software application 20 as the email requiring a certified email return receipt.

The method 100 can also include determining if the certified email return receipt feature has been purchased by the sender at 106. Referring now to FIG. 3, the sender's email application 18 determines if the email return receipt feature has already been purchased by the sender at 150. The purchase of this feature by the sender can be implicit in the fact that the sender is using the email application 18 having the email return receipt feature. The identity of the sender can be determined by requiring the sender to log in to the email application 18 or in any other suitable known manner. The sender's email application 18 can associate the sender's identity with an indication of payment in any suitable known manner such as keeping track of such using a database such as, for example, the email return receipt database 22.

If the sender has not already purchased this feature, the application 18 can give the sender the option to use the feature on a pay per use basis at 152. If the sender does not consent to paying for using the feature at 154, the application 18 can discontinue with providing the certified email return receipt feature and allow the sender to send the email to the recipient in a known manner without generating a certified email return receipt at 156.

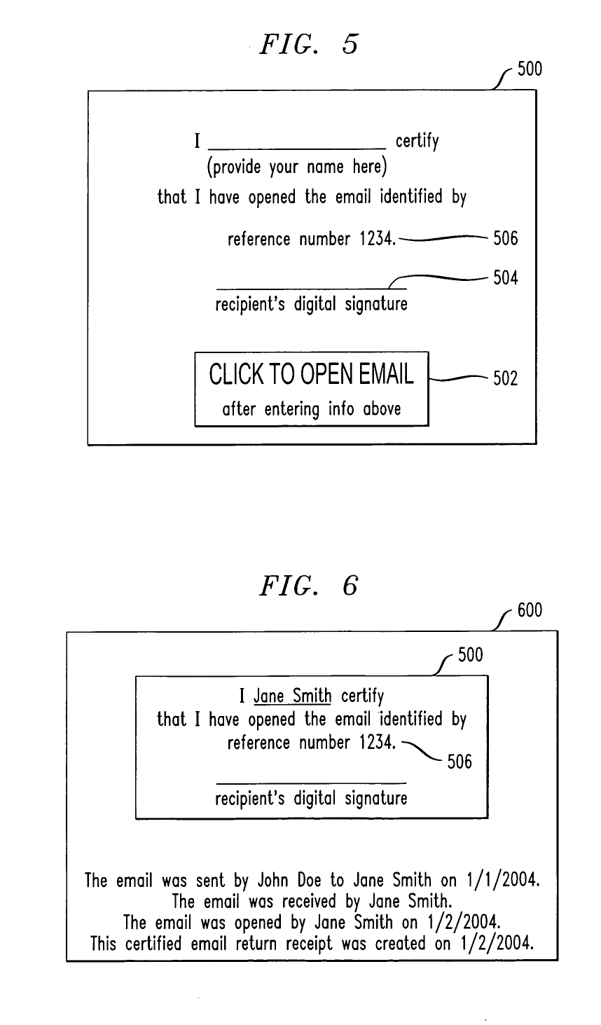

Referring again to FIG. 2, the method 100 can also include creating a reference identifier, shown as 506 in FIG. 5, which identifies the email at 108. The reference identifier 506 preferably uniquely identifies the email. The reference identifier can be numbers, letters, or combinations thereof.

The method 100 can also include logging the request in the email return receipt database 22 at 110 thereby creating an entry in the database for storing information about the email. The type of information that can be stored in the database 22 can include, but is not limited to, the sender, the recipient(s), the time and/or date of when the request for the certified email return receipt was made, the time and/or date of when the email was sent, the time and/or date of when the email was opened. The request and other stored information pertaining to the email can be associated with the email in the database 22 using the reference identifier or in any suitable manner.

The method 100 can also include sending the email to the recipient, also referred to as the addressee at 112. There can be more than one recipient. The sender's email application sends the email to the recipient's email account over the network 16 using the recipient's email address which is typically entered by the sender.

The method 100 can also include receiving the email requiring the certified email return receipt at the recipient's computer 14. The email is received in a locked condition in which it cannot be opened prior to the collection of the certified email return receipt information described below. The recipient's email application 20 recognizes that the email requires a certified email return receipt at 116 using the email return receipt request indicator described above.

Referring now to FIG. 4, the method 100 can also include prompting the person attempting to open the email, such as the recipient, to provide certified email return receipt information at 124. The certified email return receipt information can include the name of the person attempting to open the email. When a person attempts to open the email in the locked condition, the email application 20 can generate a form such as is shown generally at 500 in FIG. 5 which is displayed in a computer screen window prompting the person to enter their name and any other suitable certified email return receipt information.

The method also includes collecting the certified email return receipt information at 126. The email application 20 collects this information when it is entered at 124.

The method 100 can also include authenticating the identity at 128 of the person entering the certified email return receipt information collected at 126, such as by collecting a digital signature shown at 504 in FIG. 5, or in any other suitable known manner.

The method 100 can also include unlocking the email 130 after collecting the certified email return receipt information at 126. The email application 20 recognizes that the certified email return receipt information has been collected and only unlocks the email for opening after it is collected. The email can remain unlocked thereafter so that it can be opened.

The method 100 can also include opening the email at 132 for reading of the contents by the person entering the certified email return receipt information. The recipient's email software application 20 opens the email after collecting the certified email return receipt information at 126. The email application 20 can automatically open the email after collecting the certified email return receipt information. Forcing the recipient to enter the certified email return receipt information before opening the email, and then automatically opening the email for the person entering this information after this information is collected ensures that the certified email return receipt can accurately certify that the email was received, and opened for, the person entering the certified email return receipt information. This certified email return receipt feature forcing the recipient to enter the certified email return receipt information before opening the email for reading can be applied to the emails sent to all of the recipients listed in the “To” portion of the email, while exempting those recipients listed in the “Cc” portion.

The method 100 can also include generating the certified email return receipt at 134 certifying that the email was received by the person who entered the certified email return receipt information. The certified email return receipt can also certify that the email was opened for the person who entered this information. An example of a certified email return receipt is shown generally at 600 in FIG. 6. The certified email return receipt 600 can also include the reference identifier 506 described above for associating the email with the certified email return receipt.

The certified email return receipt 600 can also include the name of the sender and the recipient(s) of the email, the time and/or date of when the request for the certified email return receipt was made, the time and/or date of when the email was sent, the time and/or date of when the email was opened.

The method can also include sending the certified email return receipt 600 to the sender at 136. The email application 20 can automatically send the certified email return receipt 600 as an email to the sender using the sender's email address. Alternatively, the email return receipt 600 can be sent as hardcopy via postal mail. The email return receipt 600 can be stored in the email return receipt database 22.

It is to be appreciated that particular elements or components described herein may have their functionality suitably implemented via hardware, software, firmware or a combination thereof. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing communications via email comprising:
receiving an email requiring a certified email return receipt in a locked condition;
prompting a person attempting to open the email to enter certified email return receipt information;
collecting the certified email return receipt information entered by the person attempting to open the email;
unlocking the email thereby enabling the email to be opened after the collecting step;
opening the email after the collecting step for the person who entered the certified email return receipt information; and
generating a certified email return receipt certifying that the email was received by the person who entered the certified email return receipt information.

2. The method defined in claim 1 wherein the certified email return receipt certifies that the email was opened for the person who entered the certified email return receipt information.

3. The method defined in claim 1 wherein the certified email return receipt information includes the name of the person attempting to open the email.

4. The method defined in claim 3 further comprising:
authenticating the identity of the person who entered the certified email return receipt information for whom the email was opened in the opening step.

5. The method defined in claim 4 wherein the authenticating step comprises collecting a digital signature of the person who entered the certified email return receipt information.

6. The method defined in claim 1 further comprising:
sending the email return receipt to the sender.

7. The method defined in claim 1 further comprising:
receiving a request for a certified email return receipt; and
logging the request for the certified email return receipt in an email return receipt database.

8. The method defined in claim 1 further comprising:
creating a reference identifier identifying the email; and
including the reference identifier in the certified email return receipt for associating the certified email return receipt with the email.

9. The method defined in claim 1 further comprising:
storing the email return receipt in the email return receipt database.

10. The method defined in claim 1 further comprising:
including the time and/or date of when the collecting step occurred in the certified email return receipt.

11. The method defined in claim 1 further comprising:
including the time and/or date of when the email was sent by the sender in the certified email return receipt.

12. The method defined in claim 1 further comprising:
including the email subject in the certified email return receipt.

13. The method defined in claim 1 further comprising:
including the name of the recipient in the certified email return receipt.

14. The method defined in claim 1 further comprising:
including the name of persons referenced in the cc portion of the email in the certified email return receipt.

15. The method defined in claim 1 further comprising:
determining if the sender has purchased the certified email return receipt feature for generating the certified email return receipt.

16. The method defined in claim 16 further comprising:
providing the sender the option to use the email return receipt feature on a pay per use basis.

17. The method defined in claim 1 wherein the prompting step comprises providing a form in a window to be completed by a person attempting to open the email.

18. A method of providing communications via email comprising:
receiving an email requiring a certified email return receipt in a locked condition;
collecting certified email return receipt information entered by a person attempting to open the email;
unlocking the email thereby enabling the email to be opened;
opening the email after collecting the certified email return receipt information; and
generating a certified email return receipt certifying that the email was opened for the person entering the certified email return receipt information collected in the collecting step.

19. A method of providing communications via email comprising:
receiving an email requiring a certified email return receipt in a locked condition;
requiring a person attempting to open the email to enter certified email return receipt information prior to opening the email for reading;
opening the email for reading; and
generating a certified email return receipt certifying that the email was opened for the person entering the certified email return receipt information.
